(19) United States
(12) Patent Application Publication
(10) Pub. No.: US 2014/0081444 A1
(43) Pub. Date: Mar. 20, 2014

(54) SEQUENCER SYSTEM FOR AN AUTOMATIC TAPE LAYING AND PROJECTION SYSTEM

(71) Applicants: Todd W. Rudberg, Shoreline, WA (US); Joshua M. Cemenska, Mukilteo, WA (US)

(72) Inventors: Todd W. Rudberg, Shoreline, WA (US); Joshua M. Cemenska, Mukilteo, WA (US)

(21) Appl. No.: 13/621,930

(22) Filed: Sep. 18, 2012

(51) Int. Cl. G05B 19/18

(52) U.S. Cl. CPC G05B 19/182
USPC 700/142

(57) ABSTRACT

An integrated system for building a fiber composite part which includes an automatic fiber placement machine and a laser projector for verification of proper fiber placement. The CNC machine is controlled by a build file, with the laser projector being controlled by a part projection file. A sequencer, responsive to both the build and projection files, automatically controls the sequence of operation of the building of the part and the projection of the boundary information. A display shows the fiber placement information and allows the user to select a particular region of the fiber placement for verification of proper placement.

### TECHNICAL FIELD

This invention relates generally to automatic fiber placement and/or automatic tape layup machines for depositing carbon fiber material on a surface member for construction of various parts, and more specifically concerns system coordination between the various components of an automatic fiber placement (AFP) or automatic tape laying (ATL) system, including the user interface, the fiber placement machine and a laser projector which is used to verify correct placement of the fiber material.

### BACKGROUND OF THE INVENTION

An automatic fiber placement system (AFP) or automatic tape layup (ATL) machine, referred to generally herein as fiber placement machines, operate to place a strip or strips of carbon fiber material, known as tow, onto a surface member, under CNC control. The carbon fiber strips are placed in various patterns, forming layers onto the surface member, which eventually forms a finished part. Such parts are useful in many applications, including modern aircraft parts, such as a fuselage, etc. A laser projector is used to create visible patterns on selected portions of the positioned fiber strips to verify the correct placement of the fiber strips. In current systems, the laser projector and the fiber placement machine have independent references to the part being constructed, controlled by independent build sequence files.

The references between the laser and the machine relative to the part are typically produced from digital models of the final part and are generated independently from each other with independent files, referred to generally herein as part build files. The part build files are used to control the fiber placement process and the placement verification process. Errors can occur during the fiber-laying process, due to various factors, including errors in placement location accuracy, resulting in unwanted overlaps or gaps between two tows or errors in layup quality, such as in dropped individual strips, twists in the individual strips, or splice breaks in the run of fiber material.

The disadvantage of current systems is that the laser projector, projecting boundary lines onto the part being constructed for verifying proper fiber placement, is controlled and commanded from a laser-specific interface and file that is independent from the fiber placement machine interface and file. Coordination between the fiber placement machine and the laser projector is left to machine operators to manually control, i.e. the particular sequence of fiber-laying and laser projection, which results in an accurate and complete fiber-laying process to form a part must be ultimately controlled by the operator, which adds considerable time for the part production.

### DISCLOSURE OF THE INVENTION

Accordingly, the present integrated system for building a part using automatic fiber placement and laser projection verification, comprises: a CNC controlled machine for placing carbon fiber tow onto a surface member to produce a layered composite part, the CNC machine controlled by a part file; a laser projector for projecting the on a selected portion of the fiber tow, the laser projector controlled and responsive to a laser-oriented pattern file for said part; and a sequencer assembly, including a display, responsive to a sequence software file for sending data to or for controlling the operation of the CNC machine and sending data to or for controlling the laser projector in a selected sequence, wherein the machine produces fiber tow placement and the laser projection provides visual information on the part for the user.

### BRIEF DESCRIPTION OF THE DRAWINGS

FIG. 1 is a perspective view showing the relationship between a conventional fiber placement machine and a surface member upon which the fiber is laid.

FIGS. 2 and 3 show the various parts of the current fiber-laying system, their integration into a complete automatic system and the functionality thereof.

FIG. 4 shows a laser boundary projection indicating a correct placement of a portion of a single strip of fiber, while FIG. 4B shows a laser projection indicating an incorrectly laid strip of fiber.

FIGS. 5-11 are software flowcharts showing the software structure of the current system.

### BEST MODE FOR CARRYING OUT THE INVENTION

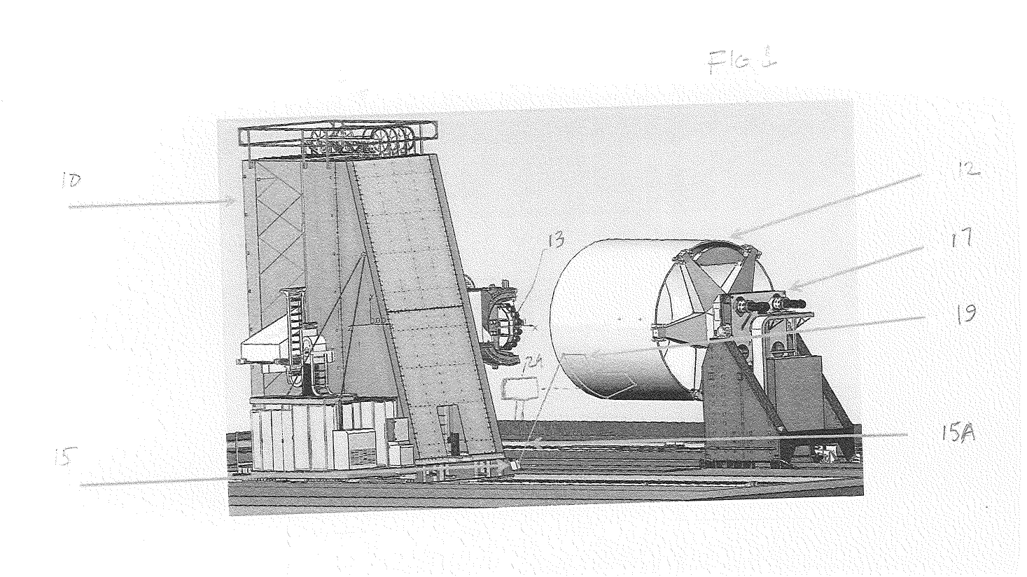

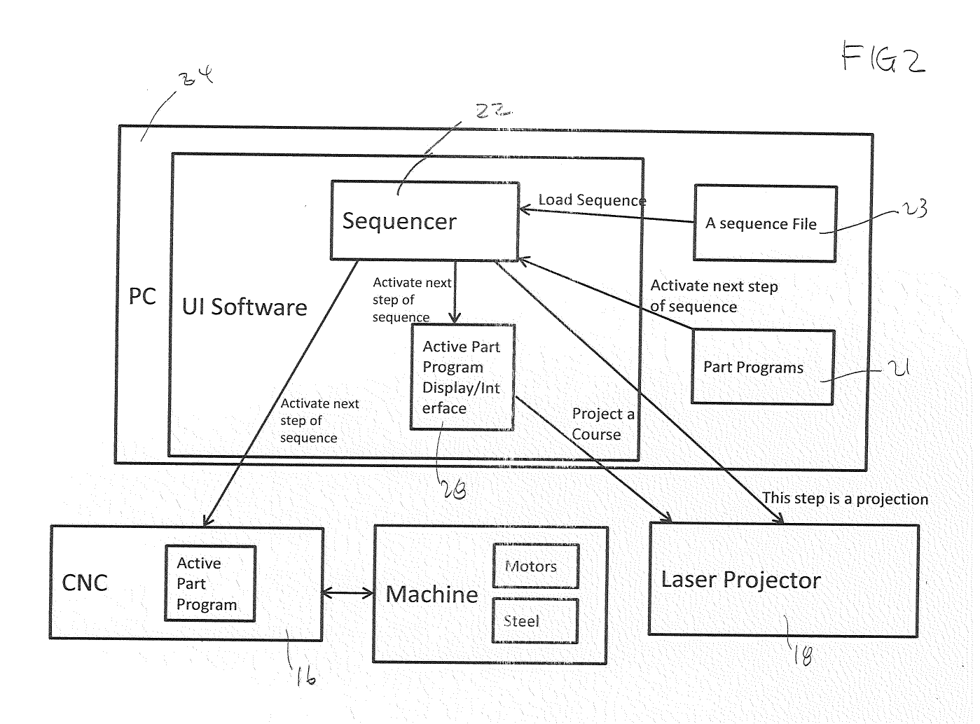

FIG. 1 shows a fiber placement machine operating under CNC (computer numerical control), generally at 10, relative to a surface member 12, sometimes referred to as a tool, upon which is constructed a desired part, which is the final result of the fiber-laying process. The CNC machine is a motion platform designed for accurate path motion and typically includes a number of individual heads 13, each of which includes one or more spool of carbon fiber material. The composite material which is laid to produce the part is in the form of narrow strips, called tows; with the CNC machine 10 controlling how many tows are laid in one pass of machine travel over the surface member.

The combination of a set of tows laid up at the same time by the multi-head machine is called a course. A course is the material laid down in one pass of the machine 10 over the surface member. A set of courses which together cover a selected region with a layer of fiber material is typically called a ply. Further, a collection of several plys that are laid along a similar direction or path such that none overlap is called a sequence. By laying sequence after sequence on top of each other, eventually a part is formed on the surface member 12.

However, every tow, course, ply and sequence discussed above must be inspected to ensure proper layup and ultimately a correctly constructed part. Typically, CNC fiber placement machines often need to cover a large area, with one to 32 or more tows in each course, with one to several hundred courses in each ply, and between one and several hundred plys in each sequence. Lastly, a range of 1-100 sequences forms the desired part.

As indicated above, in current systems, part pattern files include part coordinates to the laser. The laser space coordinates are converted from part coordinates to laser coordinates by the laser software for ultimate projection onto a desired portion of the placed fiber material. The projection files are static and relate to a part from the standpoint of a single location. Projection files for the laser for complex parts are typically generated from CAD models using software designed to directly interface with the laser projector. The laser projector is controlled and commanded from a laser-specific interface. The same arrangement is true, as indicated above, for the CNC machine portion of the system. In current systems, coordination between the laser projector and the CNC machine is left to a machine operator using manual control. FIG. 1 also shows the laser projection 15, mounted on the machine 10 and a mechanism for rotating the surface member/part 17. Also shown is a ply boundary 19 projected on the part by a projected laser beam 15A.

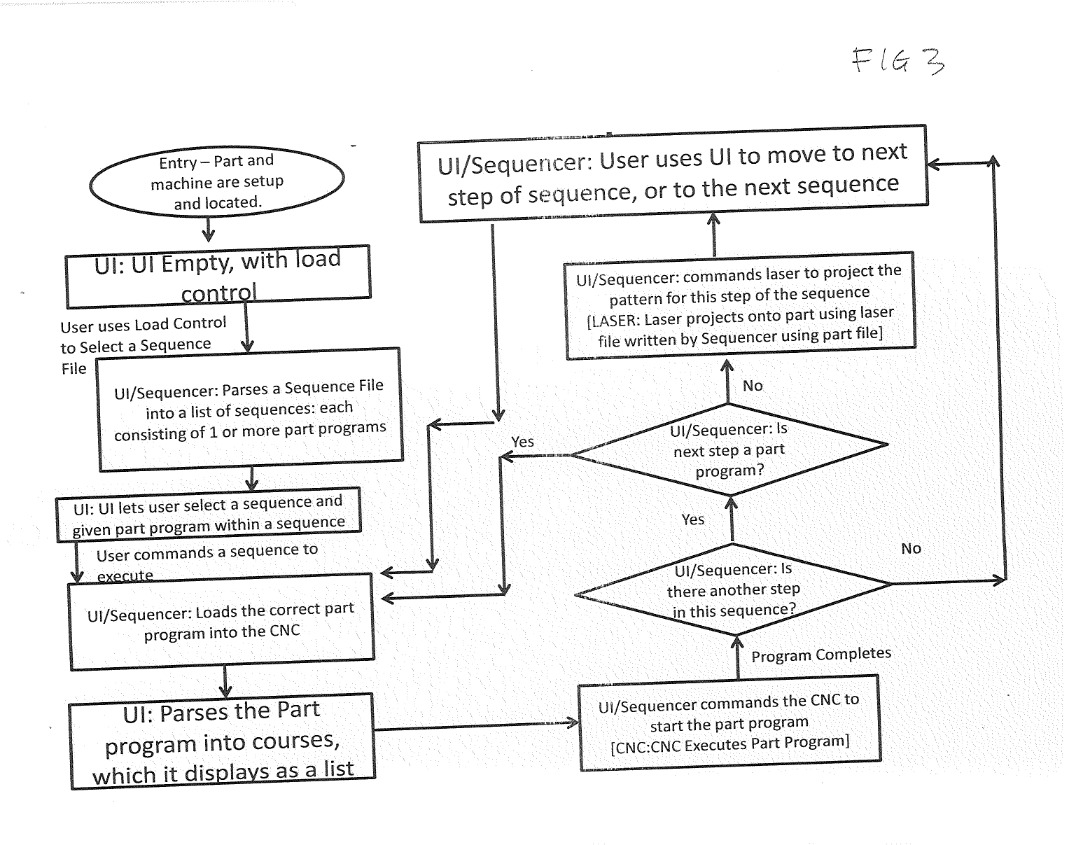

Referring now to FIGS. 2 and 3, the present system integrates the entire placement sequence operation and verification, including the placement of tow by the CNC machine and the operation of projection for verifying correct placement of the tow. The CNC machine with its part program is represented at 16, while the laser projector is represented at 18. The CNC machine is movable, with each position being known. In the present system, order-dependent part programs 21 are loaded in sequencer 22 present in a system computer 24. A sequence file 23 is loaded into the sequencer 22. The parts programs in the sequencer in computer 24, after processing, control both the fiber machine 16 and the laser projector 18. The part build sequence (the actual fiber-laying steps) and the laser projection process steps are now controlled by the sequencer 22 in the computer.

Individual steps that result in the placement of the fiber material are followed by laser projection steps at the proper time in a selected sequence to promote continuous visual inspection of the part and verification of correct placement of the fiber material. The active part program is displayed at 28 for the user, step by step in the sequencer. The sequencer 22 logs each fiber placement and sequence projection operation, integrating the overall part production process in a single interface. The sequencer also has the capability of collecting information from the laser projector and using it to alter instructions sent to the CNC machine or recording it. All of the operations for building of the part are thus now controlled by the sequencer and the software therein on the computer. This arrangement eliminates the need for the user to learn two separate pieces of build sequence software, in addition to ensuring that they are synchronized to build the part quickly and accurately. The step-by-step function of the sequencer with the user interface (U/I) is shown in FIG. 3.

In the present arrangement, the part projection data for the laser can be sent from the sequencer directly to the laser where the laser calculates the part to laser coordinates transformation to the part, or the laser data can be transformed to a common machine reference system (FRC—fixed reference coordinates) and then sent to the laser. The laser can compute the reference coordinate to laser coordinate transformation. The latter method is often preferred when the laser is movable or when the tool is moved, such as when it rotates.

As discussed above, part programs are loaded into the CNC machine and are controlled by the sequence software. Individual placed courses by the machine, comprising as stated above a series of tows, are identified and displayed in the user interface 28. The interface provides commands to project a single placed course from the build program. The user selects a particular course, such as graphically on the user interface display, to command a projection by the laser projector on a particular course. Using the part program source file, the present sequence software isolates the selected course from other courses that are part of the same layup ply, parses the position commands and transforms the position commands from part coordinates to FRC coordinates. It in essence calculates the anticipated fabric course position relative to the CNC program that is used to lay the course. This is done without any additional user interaction. The resulting positions represent the expected course centerline, which can be converted into a course boundary. The course boundary, once projected, can then be visually inspected by an operator. The operator, upon finding a flaw identified by the laser projection, can see the error in the course, remove only that particular course, and then instruct the machine to lay the removed course again. The operator can proceed to again inspect it and verify its current placement.

Alternatively, the set of positions can be trimmed to contain only those points on the part that are visible to the laser by direct line of sight, and where the expected intersection angle of the laser is small enough that it does not generate a large distortion error (typically more than 30° of offset from a perpendicular intersection of the laser with the surface). The set of positions is written to a projector file that is then sent to the laser for projection. As the part moves, the projector file is updated to transform the projection points to match the course location given the new part location, thus providing a dynamic projection that tracks motion of the part being constructed. For a part that requires rotation for full laser-assisted inspection, this permits the sequencer to ensure that the combination of all areas that were projected is the total area of all courses that the part build program attempted to lay up.

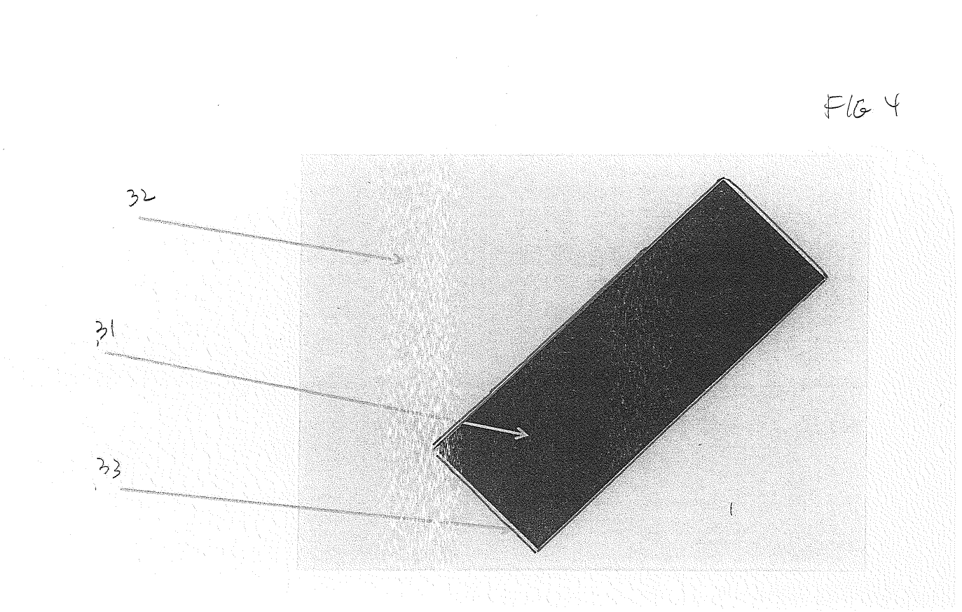

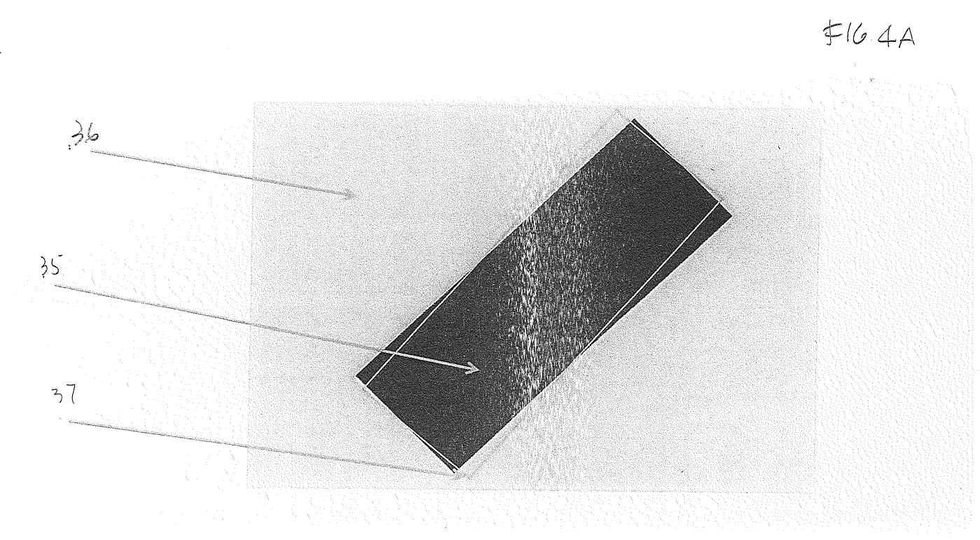

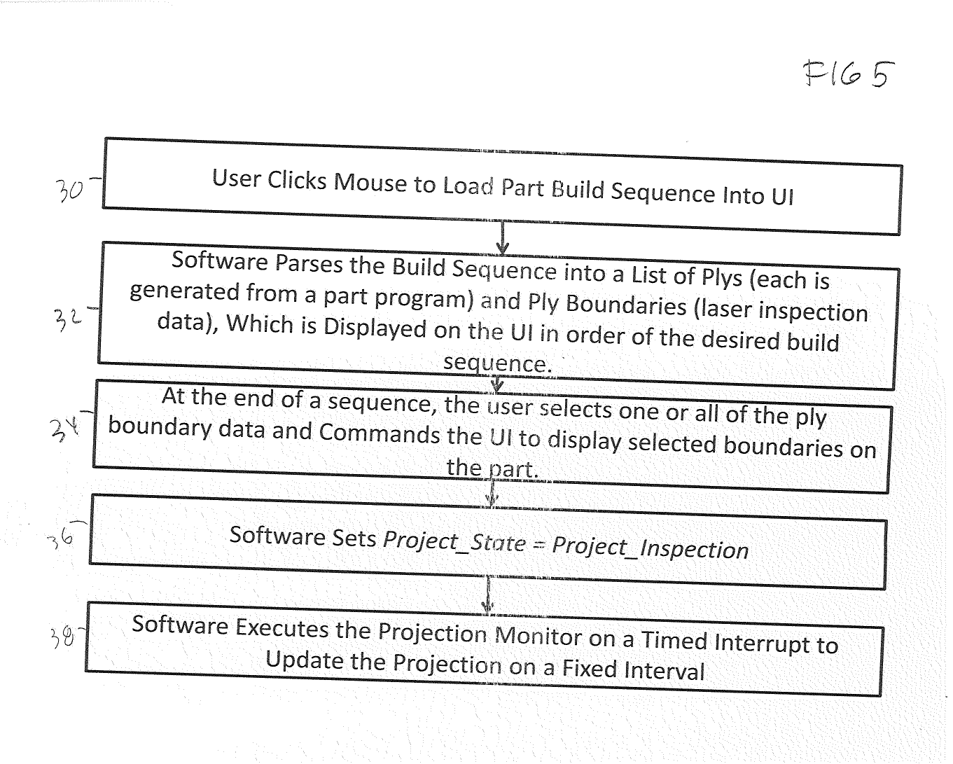

FIG. 4 illustrates very simply a portion of a tow 31 which has been accurately laid down as a part 32, as indicated by the projected boundary 33, while FIG. 4A indicates a portion of a tow 35 which has been incorrectly placed on a part 36, as shown by the projected boundary 37. Correction is needed by the operator for the example of FIG. 4A.

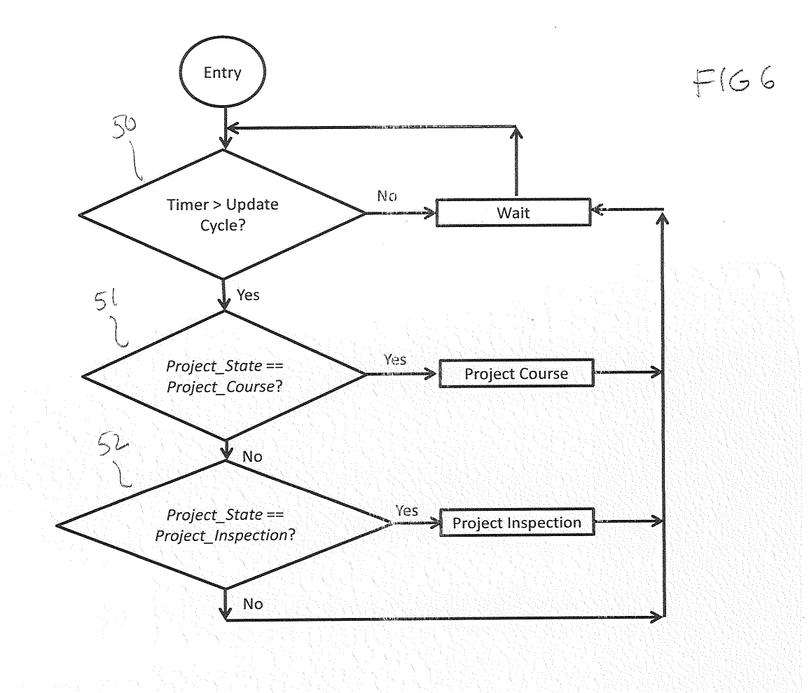

FIGS. 5-8 show the inspection projection software flowchart. The requirements for the software include a sequence file which is a collection of sequences of ply layup data and ply projection data. The projection data includes position commands listed line by line, with the position in part coordinates. The projection data further includes a normal vector of the part surface indicated by each position command, in the part coordinate system. The software includes fixed reference coordinates which are defined by particular physical benchmarks on the part. The laser projector includes communication with the computer running the software, with the laser projector either being fixed or mounted on a moving machine. The sequencer software consists of a series of individual sequences. Each sequence has one or more part programs that constitute a ply and inspection data which projects their ply boundaries.

FIG. 5 shows the user interface flowchart for the projection verification sequence. The user interface includes a loading of the build sequence into the user interface, at block 30. The software then parses the build sequence into a list of plys and ply boundaries, at block 32. At the end of a sequence in the build process, the user selects one or all of the ply boundary data and commands the user interface to display selected boundaries on the part, at block 34. The software next sets the state of the laser projection to projection inspection, block 36, and executes the projection monitor on a time interrupt (fixed internal) basis.

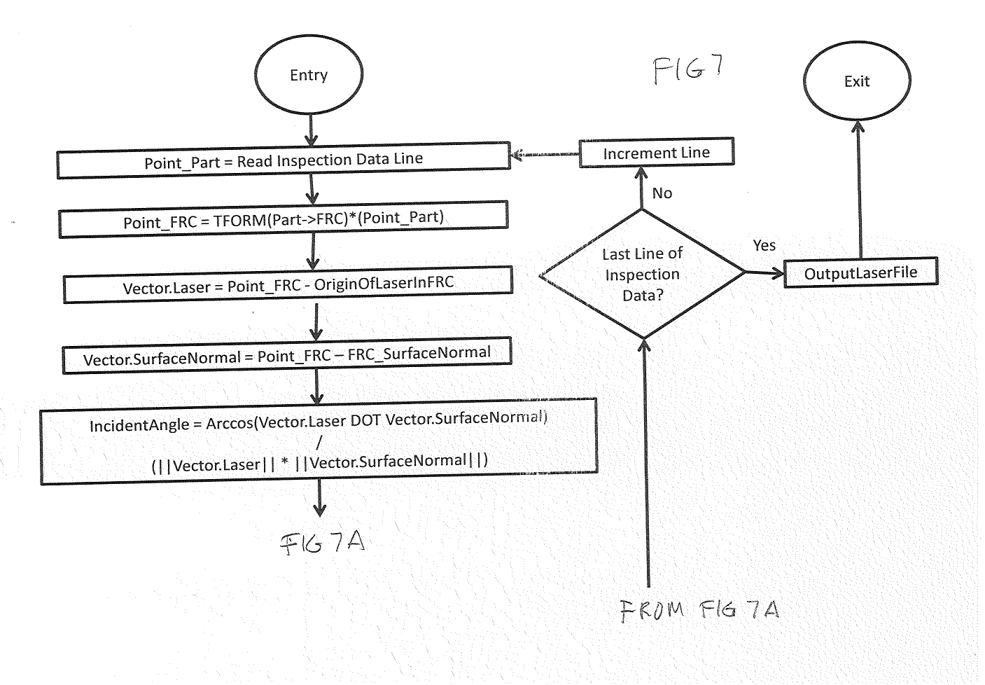

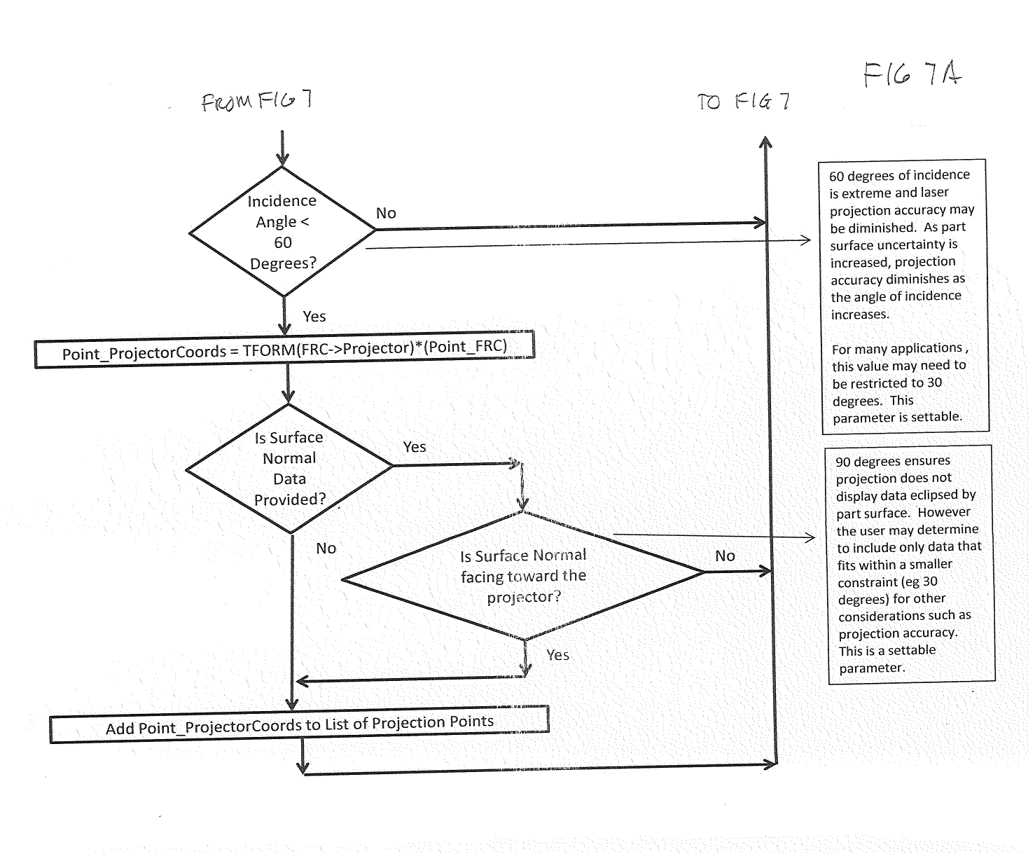

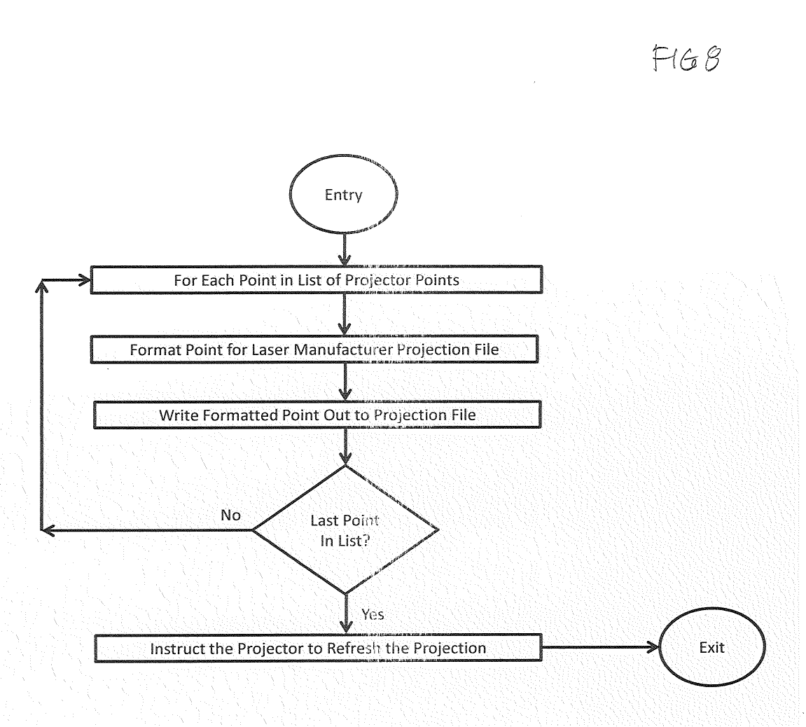

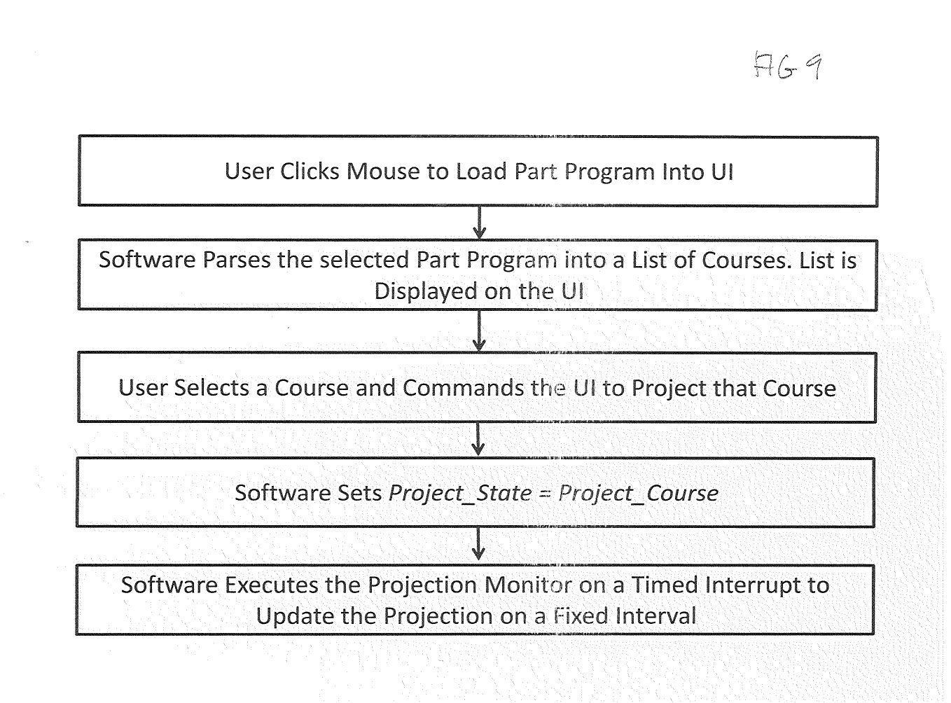

The projection monitor flowchart is shown in FIG. 6. A timer 50 is set to a particular cycle, such as for instance 500 milliseconds. The projection state is then determined, either projection of boundary information 52 or projection of course information 51. The projection inspection flowchart is shown in FIGS. 7 and 7A. It transforms part data into FRC data by multiplying the part data by the part to FRC transform. Vector and incident laser angle are then evaluated to ensure that the angle is within a selected value range. When the last line of inspection data is completed, the program goes to the output laser file shown in FIG. 8.

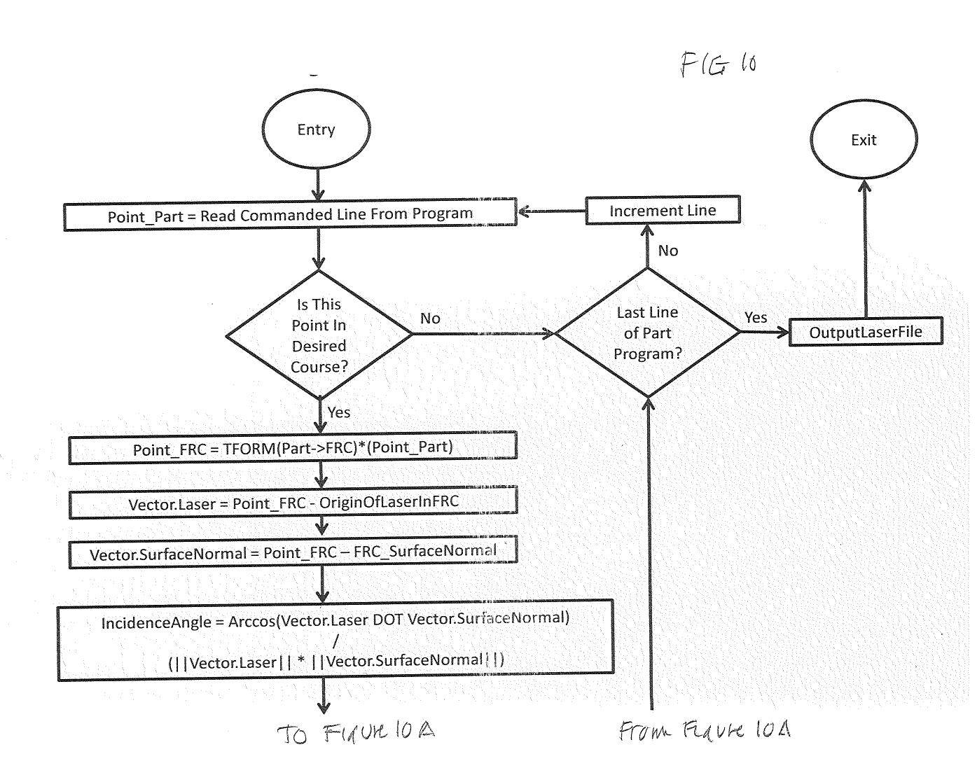

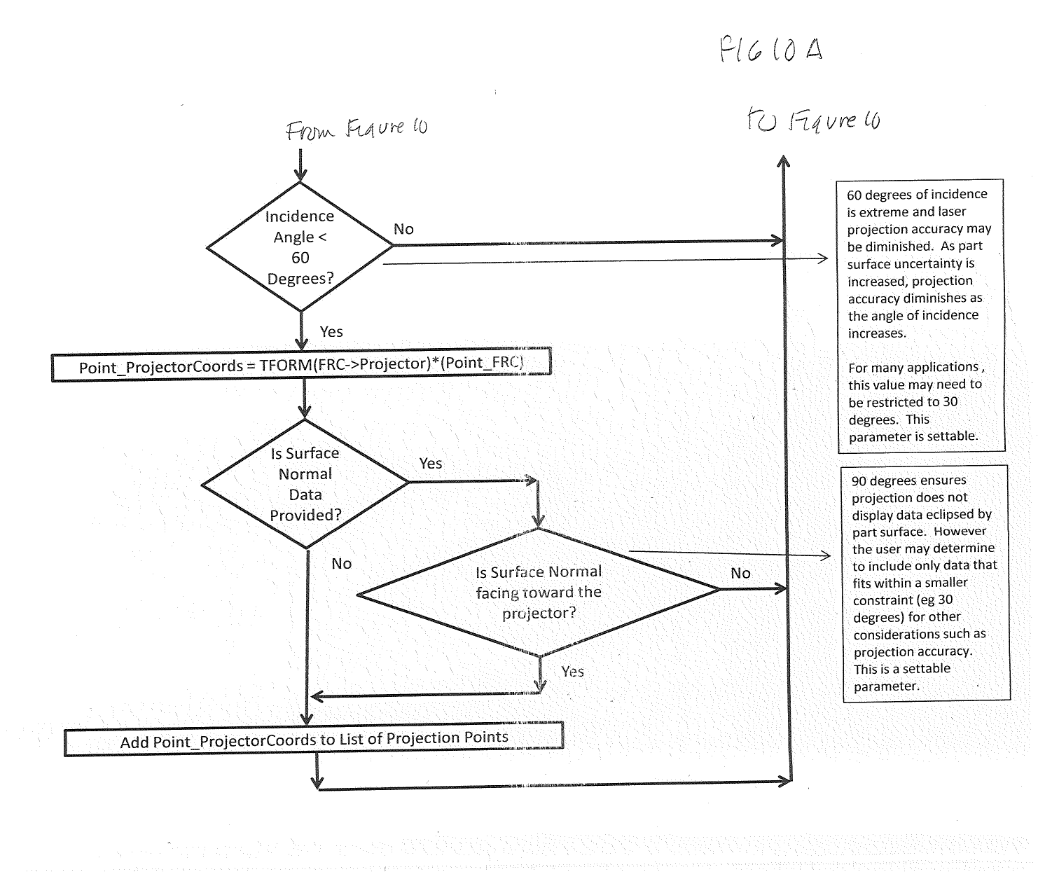

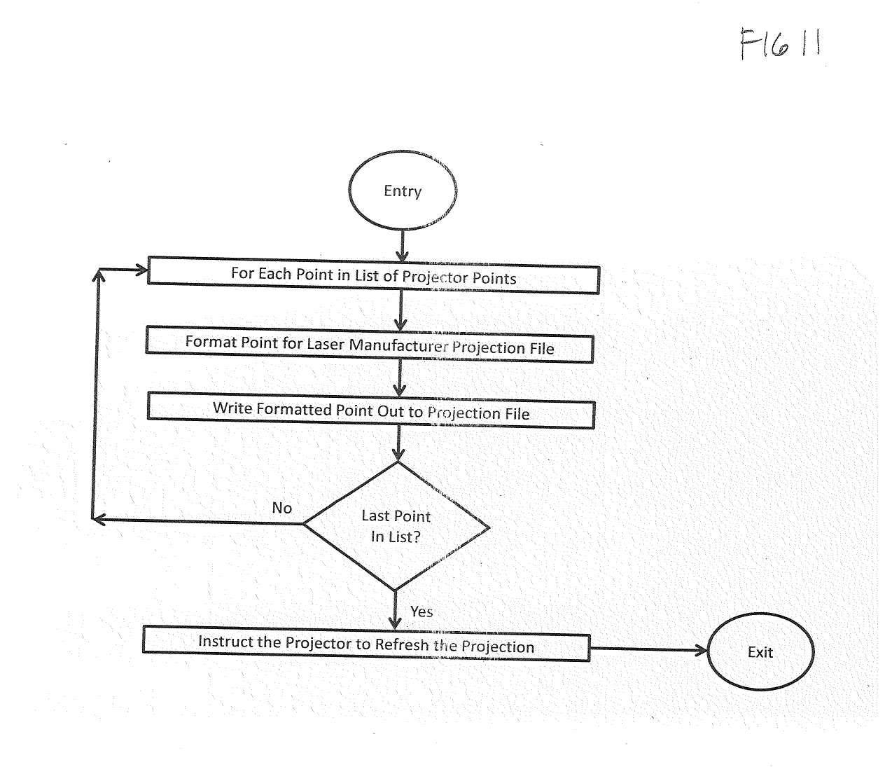

The software can also set the user interface projection monitor (FIG. 6) to projection of a course, which is shown in FIGS. 9, 10 and 10A. FIG. 9 is similar to FIG. 5, except that its projection state is for a course. Each point in a course is read from a line in the program (FIG. 10). A determination is made as to whether the point is in the desired course. The point in the FRC is then determined by multiplying the space point by the part to FRC transform. The vector and incident angle are determined and evaluated. This is repeated for each line in the part program. The program then proceeds to the laser file output, FIG. 11, which completes the course identification process. The result is a boundary or a centerline identification of a selected course.

With the present system the centerline of a tow can be projected or a single point can be projected. The projected boundaries of a tow or course can also include a tolerance region. As indicated above, boundary information is regarded as valid only if the angle of incidence is less than a particular value. This angle could be 60° or a preset value in the sequence file or less than the value based on a known performance and position of the laser and position and normal to the surface data in the part file.

In addition, a camera can be mounted with a view of the part to aid the operator in registration and to permit usual inspection of the area being projected (shown generally at 29 in FIG. 1). It is preferable that the camera be located proximate to the laser projector, to reduce parallax errors.

Accordingly, a system has been described which comprises an integrated system for laying down strips of composite on a surface member to produce a final part, and for providing ply boundary information and/or course centerline information in order to verify the correct placement of the tow. This present system aids in the automatic coordination between the two processes.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An integrated system for building a part using automatic fiber placement and laser projection verification, comprising:
a CNC controlled machine for placing carbon fiber tow onto a surface member to produce a layered composite part, the CNC machine controlled by a part file;
a laser projector for projecting the on a selected portion of the fiber tow, the laser projector controlled and responsive to a laser-oriented pattern file for said part; and
a sequencer assembly, including a display, responsive to a sequence software file for sending data to or for controlling the operation of the CNC machine and sending data to or for controlling the laser projector in a selected sequence, wherein the machine produces fiber tow placement and the laser projection provides visual information on the part for the user.

2. A system of claim 1, wherein the visual information is a centerline projection of a selected course.

3. A system of claim 1, wherein the visual information is a boundary projection of a selected course comprising a plurality of tows.

4. A system of claim 1, wherein the visual information is a centerline projection of a selected tow.

5. A system of claim 1, wherein the usual information is a boundary projection of a selected course.

6. A system of claim 1, wherein the boundary projection is valid only if the angle of incidence of the laser projection relative to the part is less than 60°.

7. A system of claim 1, wherein the location of errors in the placement of fiber tow placement is projectable onto the part.

8. A system of claim 1, wherein the laser projector is movable from a first known location to a section known location and wherein data is transformed so that projections for the second known location is accurate.

9. A system of claim 1, wherein the visual information is boundary projection, and wherein the boundary information is valid only if the angle of incidence of the laser projection is less than then a preset value set in the sequence file.

10. A system of claim 1, wherein the visual information is boundary projection and wherein the boundary information is valid only if the angle of incidence of the laser projection is less than a value generated by computing an error limit based on a known performance and position of the laser and the position and normal data in the part file.

11. A system of claim 1, wherein the sequencer assembly includes an interface which displays the current part build state and permits section of courses by the user display.

12. A system of claim 11, wherein the selection of courses is accomplished by use of a visual display.

13. A system of claim 1, including a camera positioned such that it provides visual feedback for the laser projection.

14. A system of claim 1, wherein the camera is positioned such that the operator can view the laser projection on the part, and the section of the part projected on from the same computer system.

15. A system of claim 4, wherein the projected boundary includes a selected tolerance area.

16. A system of claim 5, wherein the projected boundary includes a selected tolerance area.

17. A system of claim 1, wherein the sequence assembly collects information from the laser projector, and uses it to alter instruction sent to the CNC machine.

18. A system of claim 1, wherein the sequence assembly can collect information from the laser projector and record it.
